(19) United States
(12) Patent Application Publication
(10) Pub. No.: US 2013/0175976 A1
(43) Pub. Date: Jul. 11, 2013

(54) Battery Management System

(71) Applicant: Salim Rana, Calgary (CA)

(72) Inventor: Salim Rana, Calgary (CA)

(21) Appl. No.: 13/348,455

(22) Filed: Jan. 11, 2012

(51) Int. Cl. H02J 7/00

(52) U.S. Cl. 320/107

(57) ABSTRACT

A battery management system for the propulsion batteries of an electric vehicle comprises means for voltage sensing, temperature sensing, voltage limit sensing, and current limit sensing. Charge control is employed for optimal system operation and ensures cell balancing by detecting the lowest charged cells in a cell stack and charging those cells first, thereby ensuring that all cells charge uniformly. Charge control is accomplished on a battery management circuit board associated with battery cells in a battery box, while control of the battery management board is governed by a system controller board through a controller area network interface. The system controller board uses data from the battery management board to govern charge characteristics of the batteries, and supply data and control functions to a driver interface computer.

### BACKGROUND

The present invention pertains to rechargeable electric vehicle batteries, and in particular a battery management system to prolong the operational life of battery cells in electric vehicles. One object of the present invention is to protect battery systems misuse from the failure of adjacent systems external to the battery system's control domain. Further objects of the invention are to control cell voltage, pack voltage and temperature, and measure cell and/or package (cycle count), capacity (a function of Coulomb counting), individual cell or string internal resistance (a function of loaded vs. unloaded bi-directional power performance, vehicle speed, energy data or commands, regenerative energy data or commands, brake blending data or commands, charger data or commands and any other control oriented data.

Battery management systems may be designed as active, passive, or a combination thereof, and may be designed to implement control algorithms internally or accept control inputs from an external source. In certain cases, external commands can be accepted and evaluated to determine a battery's ability to respond to the command.

In applications using a large number of cells, data communication with other systems generally occurs via established industry-standard protocols, such as RS232, RS485, J1850, CAN, LIN, MOST, FlexRay, etc. However, for lower cell count applications, it is possible to operate a highly simplified system without the use of these protocols, having a few discrete signals, typically 0-5 Volt “discrete I/O” which can serve to maintain control function “communication” with one or a few external systems. Such simplified communication has several advantages low cost hardware, reduce or eliminated programming requirements and comparatively simple and reliable operation.

Monitoring Cell and Pack Voltage:

By far, the safest method of control and protection involves measuring individual cell voltages. With proper control functionality, this data ensures that the operation of the pack, which is limited by the “weakest” cell in the pack, does not result in detrimental effects to any individual cell. The term ‘weakest’ refers to an individual cell's ability to provide or accept current and is closely related to a cells internal resistance.

The performance of a cell within a pack depends on relatively equal values of internal resistance and voltage compared to other cells in the pack. Internal resistance has been shown to strongly correlate to anode and/or cathode condition which typically deteriorates with a cell's cycle life. Individual cell voltage performance “softens” with this deterioration, meaning that the affected cell voltage drops readily as power is drawn.

Historically, measurement of pack voltage has typically been used to establish a pack “state-of-charge” (SOC), however, as is the case in lithium polymer (LiPol) electrochemistry, a relatively flat voltage profile makes for a highly uncertain SOC estimation when based solely on pack voltage. Rather, complex SOC algorithms must be implemented to accurately assess LiPol SOC. Pack voltage data can be used effectively as data for timely arbitration, for example, of a current command from a DC/DC converter, a propulsion controller, a charger controller or other applications.

Pack Current Measurement:

The measurement of current being processed through a pack of cells is used to assess performance to a command. Source current, providing energy to an external load (propulsion or housekeeping) is typically controlled by limits enforced by an operating strategy for propulsion and “housekeeping” loads. Often, the primary limiting parameter is a prescribed lower voltage limit. However cell or pack temperature factors should also be used to enforce such current limits.

Temperature:

Critical to the performance of a battery system is operation within safety and performance defined temperature limits. Performance limiting and shut-down algorithms based on a temperature profile assists in preventing conditions which could lead to a variety of problems such as cell deterioration due to under or over temperature conditions, and in particular, over temperature exothermic runaway (potentially leading to a fire).

It is therefore an object of the BMS of the present invention to protect cells from over charging, which might lead to an exothermal runaway reaction; and also to prevent cell damage from discharge below established limits. It is another object of the BMS to extend battery life, and extend the range of an electric vehicle using a cell array. These and other objects will become apparent from the following summary, description and claims.

### SUMMARY

The Battery Management System of the present invention employs the following functions; voltage sensing, temperature sensing, voltage limit sensing, and current limit sensing. Charge control is employed for optimal system operation, and to ensure proper cell balancing control during charging. A main charge prolongs battery charge time. The invention also comprises a SOC look-up table for monitoring and diagnosis. The SOC function monitors the voltage, current and temperature of the cells. It also performs data storage and diagnosis function, and an alarm/error message to provide warnings. Finally, a user interface is provided for communication to the electric vehicle propulsion controller and communication to the intelligent main charger.

Balancing individual cell voltages while charging can occur by charge depletion. With charge depletion, the energy contained in the higher voltage cells is converted to heat to achieve an equal uniform voltage among the pack cells. Although this method is the least efficient in terms of energy retention, this is outweighed by its simplicity and low cost of implementation. In a preferred embodiment of the present invention, the following controller boards are used to implement the various battery management activities: a system controller board, a controller area network (CAN) interface and a battery management board (BMS).

### FIGURES

FIG. 1 is a diagram of the overall system of the present invention, including the system controller board, CAN bus and battery management box comprising a BMS board and battery cells.

FIG. 2 is a diagram of the BMS battery box of the present invention comprising temperature inputs and circuit shunting circuitry.

FIG. 3, is a diagram of the system controller board and associated interfaces of the present invention, including the connection of the system controller board to the BMS.

### DESCRIPTION

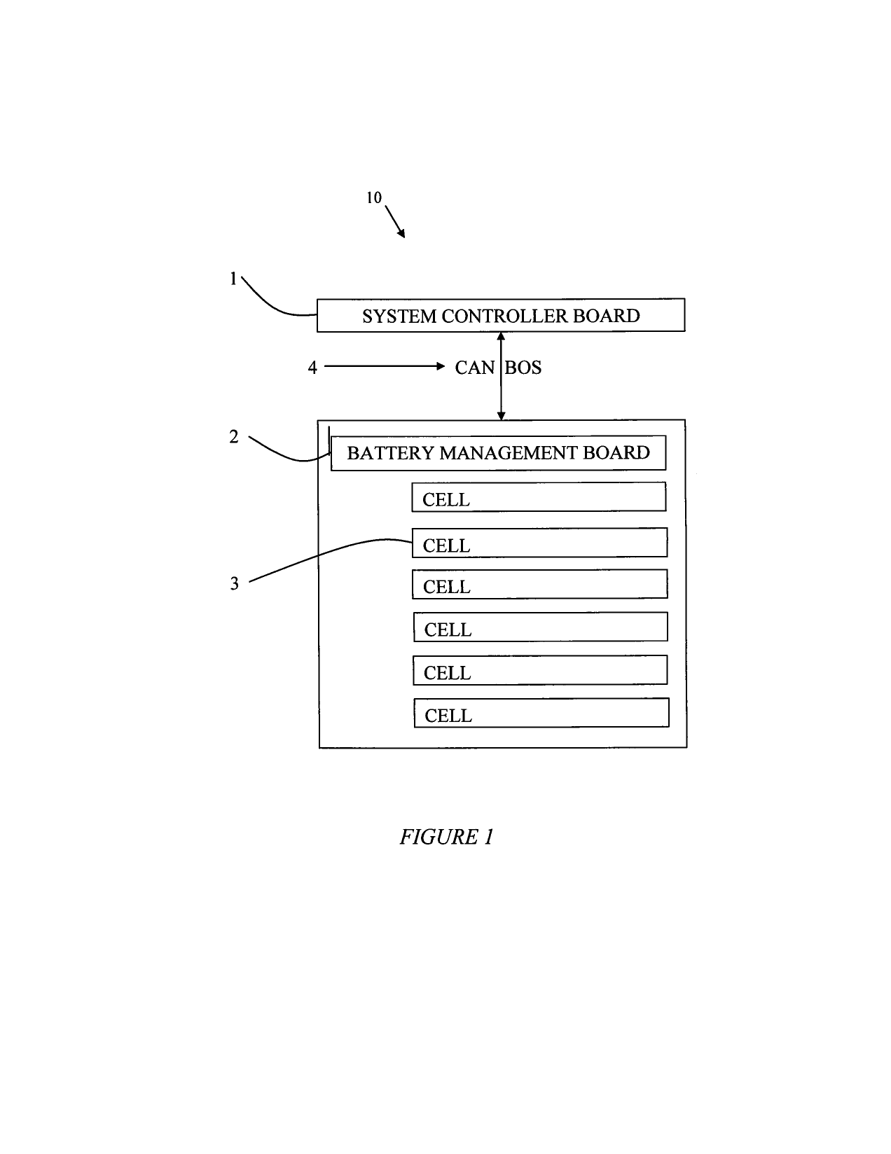

Referring to FIG. 1, a system for managing the battery power in an electrically powered vehicle is shown. The system comprises a system controller board 1 connected via a controller area network (CAN) bus 4 to a battery management system (BMS) board 2 and battery array 3. The BMS board monitors the charge of individual batteries and governs the flow of electricity to individual batteries in the array; in a manner that charges less highly charged cells first, allowing them to “catch up” to more highly charged cells. In this manner, the cells are always charged evenly. prolonging the life of the cells.

Specifically, the BMS board reads the voltages of a group of cells, and shunts a portion, including all, charging power to the lowest charged cell or cells in the group. When the lowest charged cell or cells in the group obtain a charge higher than the formerly second lowest charged cell or cells, the EMS board shunts power to these cells. By repeating this operation, an entire array of cells may be charged evenly.

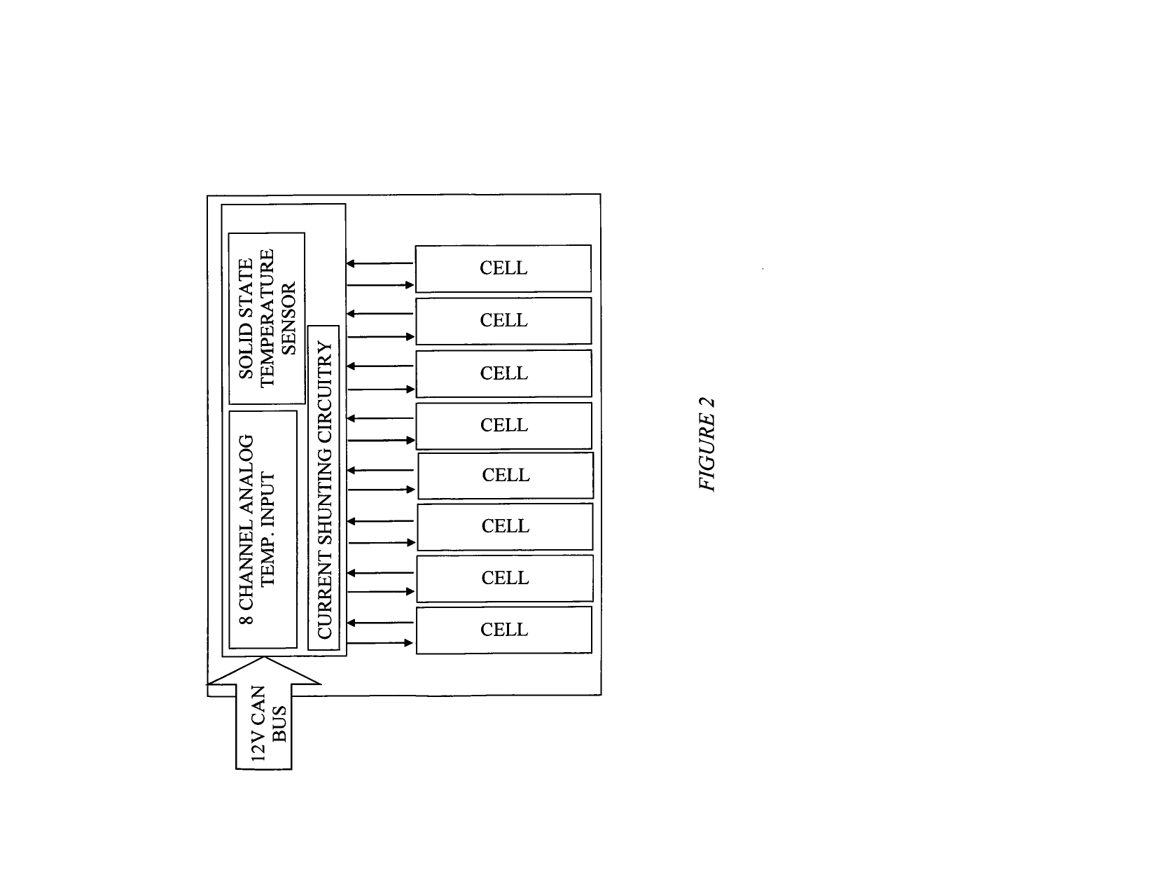

Referring to FIG. 2, in one preferred embodiment, an array of battery cells comprises an 8-cell stack, wherein each stack is associated with its own BMS board. Each cell stack and associated EMS board is contained in a battery box for protection of the cells and BMS board, and to serve as containment means in the event of a malfunction. The BMS board contains eight channels of analog input to measure cell temperature, and current shunt circuitry accomplishes charge balancing. Additionally a solid state temperature sensor measures heat sink temperature and provides a board ID.

In a further preferred embodiment, each local 8-cell stack is connected to its corresponding BMS board's analog ground in the middle of the stack to minimize common mode error. An RC circuit low pass filter at the output of each amplifier reduces high frequency noise, and a microcontroller on the system controller board controls the 12V CAN interface power on/off.

Still referring to FIG. 2, the CAN interface is optically isolated to compensate for the high voltage difference between a 12V battery on the vehicle and the voltage from the cell stack. A 120 Ω terminating resistor is connected externally at the last battery node on the CAN bus. In an alternate embodiment, the terminating resistor is externally connected. In one preferred embodiment, the total current drawn from the CAN bus does not exceed 1.2 amps. In another preferred embodiment, a standard vehicle CAN bus is used.

To measure cell voltages, high voltage unity-gain difference amplifiers, channels 1-96, are used. To minimize the potential for common mode error, each local eight-cell stack is connected to the BMS board's analog ground in the middle of the stack. A resistor-capacitor filter at each amplifier's output reduces high frequency noise. Cell voltages are then read using the BMS processor's internal 10-bit analog-to-digital converter (0-Vdd range). By reading a precision 4.096V voltage on another analog-to-digital channel, the cells' absolute voltages can be interpreted.

For data communications, the software in the BMS maps the cell voltage readings into a single byte expressing a voltage value. In one preferred embodiment, the voltage value range is 2.50V to 5.05V with a resolution of 10 mV. However, the maximum voltage that can be measured is the Vdd supply voltage. Vdd supply voltage is nominally 5V, varying according to voltage regulator tolerance. In this manner, for example, one board may be able to measure up to 5.50V, while another board may max out at 4.97V.

To monitor and maintain the temperature of each battery box, a system of thermistor inputs monitor battery cell temperature. In one embodiment the thermistors are disposed between individual cells in an array. A precision pull-up resistor forms a voltage divider between thermistors in an array. The voltage divider ratio is accurately determined by an internal analog-to-digital converter on the BMS processor. Since the reference voltage of the analog-to-digital converter and the pull-up resistor voltage are the same, the conversion is inherently ratiometric. The voltage divider ratio allows the thermistor resistance to be determined, and a look-up table yields the temperature.

Each battery box further comprises a solid state temperature sensor, measuring the temperature of a heat sink in the box. Each of the temperature sensors contains a unique identifier, in one embodiment a serial number, which can be used to uniquely identify each BMS board and the battery box with which it is associated.

The BMS board further comprises charge balancing heat sink circuitry comprising cell management channels for each of the cells in an array, including the preferred embodiment of 8 cells. A constant-current circuit controlled by a processor can draw approximately 200 mA away from its corresponding cell. This current sink circuit allows lower charged cells to “catch up” to higher charged cells.

For all cells, when the processor turns on the optoisolator, a darlington power transistor also turns on and forces current through a resistor and diode; wherein the diode provides temperature compensation to the current control loop since its forward voltage drop temperature coefficient is close to that of the transistor base-emitter on voltage. The current sink circuit is adjusted up or down by changing the value of the resistors, or by controlling the on/off duty cycle of the circuit. Most of the energy associated with the diversion of current from individual cells is conducted to a power resistor. For any cell, the power dissipation will be proportional to the cell voltage, and the overall power dissipation will increase with the number of cells balancing.

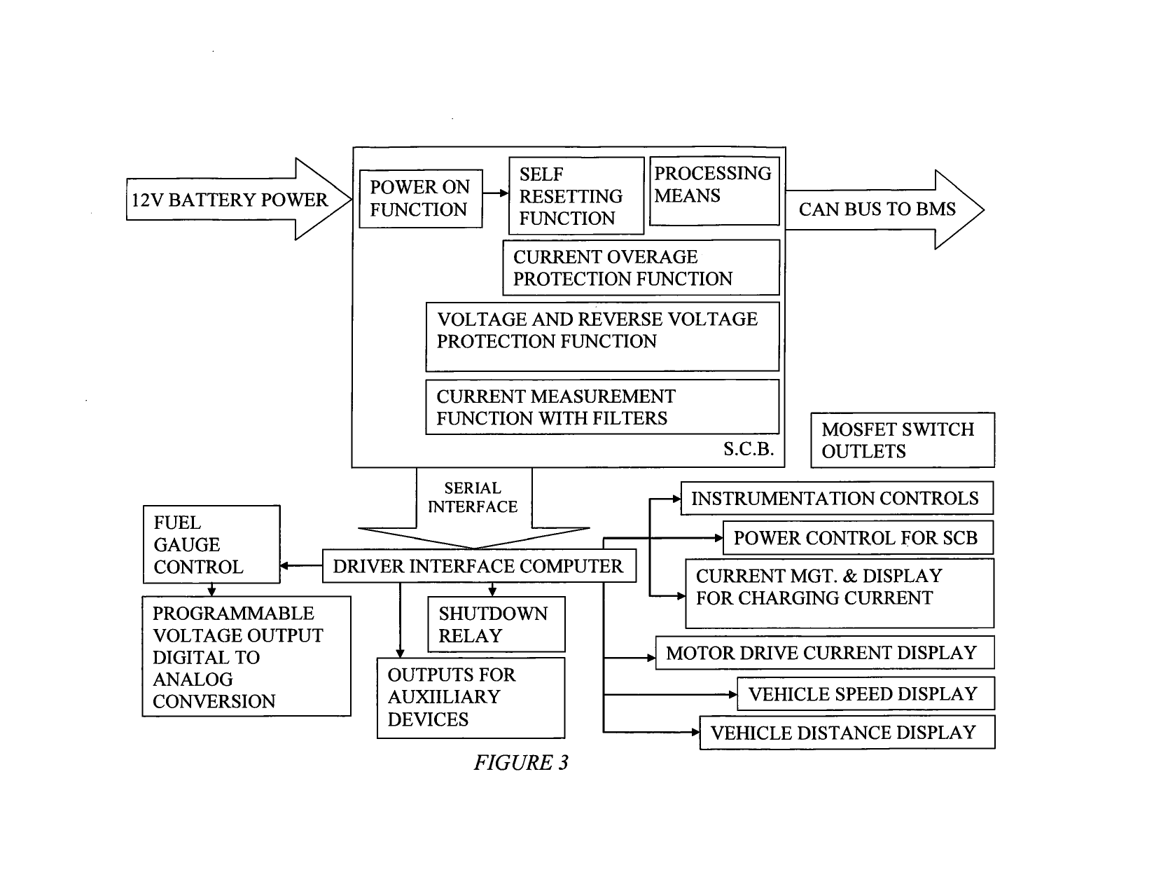

Referring to FIG. 3, the system controller board is shown and described. The system controller board comprises an means for providing a CAN interface to the battery management board, and an interface to the driver interface computer. The driver interface computer governs the vehicles instrumentation controls and provides an interface to other subsystems of the vehicle. Subsystems of the vehicle include power control of the computer; current measurement for current provided by an external battery charging means, motor drive and solar provided current; vehicle speed and distance measurement; fuel gauge control; shutdown relay; and outputs to drive auxiliary devices.

IN a preferred embodiment, the system controller board is powered by the vehicles on-board 12V battery, and comprises means for self-resetting, current overage, and voltage/reverse voltage protection.

The system controller board powers on whenever the vehicle key switch is on. In other embodiments, the board powers on if the battery charger is connected, if current is delivered from an external source, for instance a solar array, and in another embodiment, the system controller board remains on.

Auxiliary devices may be driven by high current MOSFET switch outputs. In one embodiment, two switch outputs are used. Communication with the driver interface computer is accomplished with an RS2322 serial interface. Fuel gauge control comprises programmable voltage output digital to analog conversion. A serial interface is provided on the system controller board, and in a further embodiment, two bidirectional RS232 serial interface channels are available, with a standard 9-pin D-type connector. Power, including low voltage power, and control of the power functions of the driver interface computer are also governed by the system controller board. In one embodiment, the maximum current provided by the system controller board is 1.2 amps.

The system controller board further comprises current measurement means, including current sensing functions. Current sensors may include two Hall-effect current sensor measurement channels powered by a DC-DC converter supplies power to the current sensors. The current measurement channels may be identical, and the controller board can activate and deactivate the converter to conserve power. The current measurement functions further include resistors and capacitors that form a filter that attenuates common mode and differential mode RF interference in the channels. In a preferred embodiment, the sensors comprise a difference amplifier, and gain is programmed according to the formula:

G=1+((180K)/(R21+20K)).

To address high frequency noise on the signal coming from the amplifier, and the signal is read using the system controller board's internal analog-to-digital converter.

The system controller board comprises a vehicle speed sensor interface using a differential amplifier to detect signal from a wheel speed sensor. The differential amplifier detects pulses from the transmission output shaft sensor, and lower value resistors are used to detect a decrease in amplitude input signal. Logic level signals are applied directly to the Vss+ input on the system controller board in instances where a jumper is installed, and speed signal integrity is displayed on an LED array.

The vehicle fuel gauge is driven by a digital-to-analog (DAC) converter associated with the system controller board. A 12-bit DAC is used with a programmable output voltage ranging from 0 to 4.095 volts.

In addition to subsystems, the system controller board controls the vehicle's main power. Control is obtained using a relay with both normally open and normally closed contacts. Two 10 amp, 60 volt open-drain MOSFET outputs are installed on the system controller board to control external devices.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, is to be understood that the present invention has been described by way of illustration and not limitation.

What is claimed is:

1. A system for managing the battery power in an electrically powered vehicle, comprising
a. a system controller board
b. at least one Battery Management System (BMS) board. wherein a BMS board governs the flow of electricity to individual batteries in a manner that causes less highly charged cells to charge first, ensuring that the cells charge evenly, while preventing battery overcharge and maintaining temperature limits; and
c. a Controller Area Network (CAN) bus linking the system controller board and the at least one BMS board.

2. The system of claim 1, wherein individual battery cells are connected in a battery array.

3. The system of claim 2, wherein an array of battery cells comprises an 8-cell stack.

4. The system of claim 3, wherein each 8-cell stack is associated with an individual BMS board.

5. The system of claim 3, wherein each 8-cell stack and a BMS board are contained in a battery box.

6. The system of claim 1, wherein the Controller Area Network (CAN) interface is optically isolated from the BMS to insulate against a high voltage difference between the battery cells used for propulsion, and an onboard separate standard 12V battery used for vehicle subsystems.

7. The system of claim 1, wherein the system controller board comprises an interface to at least one battery management board: an interface to the vehicle's instrumentation controls; and an interface to the other subsystems of the vehicle.

8. The system of claim 7, wherein me system controller board comprises a microcontroller and means for providing a CAN interface to one or more BMS boards; an interface to communicate with a driver interface computer, including power control of the computer; current measurement for current provided by external battery charging means, motor drive and solar provided current; vehicle speed and distance measurement; fuel gauge control; shutdown relay; and outputs to drive auxiliary devices.

9. The system of claim 8, wherein the board is powered by a standard vehicle 12V battery.

10. The system of claim 8, wherein the board comprises means for self-resetting.

11. The system of claim 8, wherein the board comprises means for current overage protection.

12. The system of claim 8, wherein the board comprises over voltage and reverse voltage protection.

13. The system of claim 8, wherein the board powers on whenever the vehicle key switch is on

14. The system of claim 8, wherein the board powers on when any event chosen from the list of; the battery charger being connected; current is delivered from an external source including a solar cell array; and wherein the board is constantly powered on.

15. The system of claim 8, wherein high current MOSFET switch outputs drive auxiliary devices.

16. The system of claim 15, wherein two switch outputs are used.

17. The system of claim 8, wherein an RS2322 serial interface is used to communicate with a driver interface computer.

18. The system of claim 8, wherein system controller board fuel gauge control comprises programmable voltage output digital to analog conversion.

19. The system of claim 1, wherein a serial interface is provided on the system controller board.

20. The system of claim 19, wherein two bidirectional RS232 serial interface channels are available, with a standard 9-pin D-type connector.
